(19) United States
(12) Patent Application Publication
(10) Pub. No.: US 2012/0237125 A1
(43) Pub. Date: Sep. 20, 2012

(54) Isolating Background and Foreground Objects in Video

(76) Inventor: Yen Hsiang Chew, Georgetown (MY)

(21) Appl. No.: 13/046,851

(22) Filed: Mar. 14, 2011

(51) Int. Cl. G06K 9/34

(52) U.S. Cl. 382/173

(57) ABSTRACT

In accordance with some embodiments, background subtraction can be performed by iteratively computing a new expected background image from an old background image using a plurality of consecutive frames. The new expected background image may be computed to be closer to a current frame's pixel value. In some embodiments, a new expected background image may be based on user supplied values so that a user may determine how fast a background image changes.

### BACKGROUND

This relates generally to graphics processing and, particularly, to background subtraction.

Background subtraction involves isolating dynamic or moving objects from their static backgrounds. Separating foreground and background objects may be useful in separately processing the foreground and background graphic objects. It may also be useful in removing one or the other of the foreground or background objects. Background subtraction is also used in digital security surveillance. Thus, in some cases, foreground objects can be matched with different background objects and vice versa.

### BRIEF DESCRIPTION OF THE DRAWINGS

FIG. 1 is a flow chart for one embodiment of the present invention;

FIG. 2 is a hypothetical plot of pixel value on the vertical axis versus position across a video frame showing the subtraction of the current frame minus the background image in accordance with one embodiment;

FIG. 3 is a hypothetical depiction corresponding to FIG. 2 showing the thresholding of the result depicted in FIG. 2 in accordance with one embodiment;

FIG. 4 is a hypothetical depiction corresponding to FIG. 2 showing an adjustment image in accordance with one embodiment of the present invention; and

FIG. 5 is a schematic depiction of a system in accordance with one embodiment.

### DETAILED DESCRIPTION

In accordance with some embodiments, background subtraction may be used to compare each frame of a video stream with its temporally neighboring frames to separate moving objects from static background. One issue that arises is that an object, such as a semi-stationary object, may be mistakenly identified as a moving object and so may be mistakenly included in the foreground image. Semi-stationary objects include things like leaves, clouds, sea waves, trees, and swaying reeds and objects whose motion is due to camera movement or whose motion is small but repetitive or random (e.g. swaying leaves). The background image should include both stationary and semi-stationary objects.

In accordance with some embodiments, the first video frame is taken as a reference background image. Then a new expected background image is computed from future frames. The expected background image is the old background image plus an adjustment value that shifts each pixel of a background image closer to the pixel values of consecutive future frames.

Thus, in some embodiments, two different modules can be used. A first module computes the foreground (moving) image and the second module updates the background (stationary/semi-stationary) image to obtain the new expected background image.

The foreground object image may be obtained by subtracting the current frame from the background image. Then the absolute value of the result is taken. A threshold operation may be used on the resulting image, in some embodiments, to extract only those pixel values that exceed a user defined threshold.

The background image updating iteratively compares the background image with the current frame and increments all pixel values of the background image that are smaller than the pixel values of the current frame. All pixel values of the background image that are greater than the pixel values of the current frame are decremented. A common value to add to or subtract from each pixel may be set by a predefined user parameter called the background adjustment value. This parameter may determine how fast the background image adapts itself to the current frame. The larger the value of the parameter, the faster the background image morphs to the current image.

Besides a predefined user parameter, the background adjustment value may also be a weighted average of the background image pixel values and the current frame pixel values. As another option, it may be a parameter that has a default value and is changeable by user. In still another embodiment, it may be the difference in pixel values between the background image and the current frame times a scaling parameter. In other embodiments, the parameter may be any other parameters (static or dynamic) that will morph the background image closer to the current image.

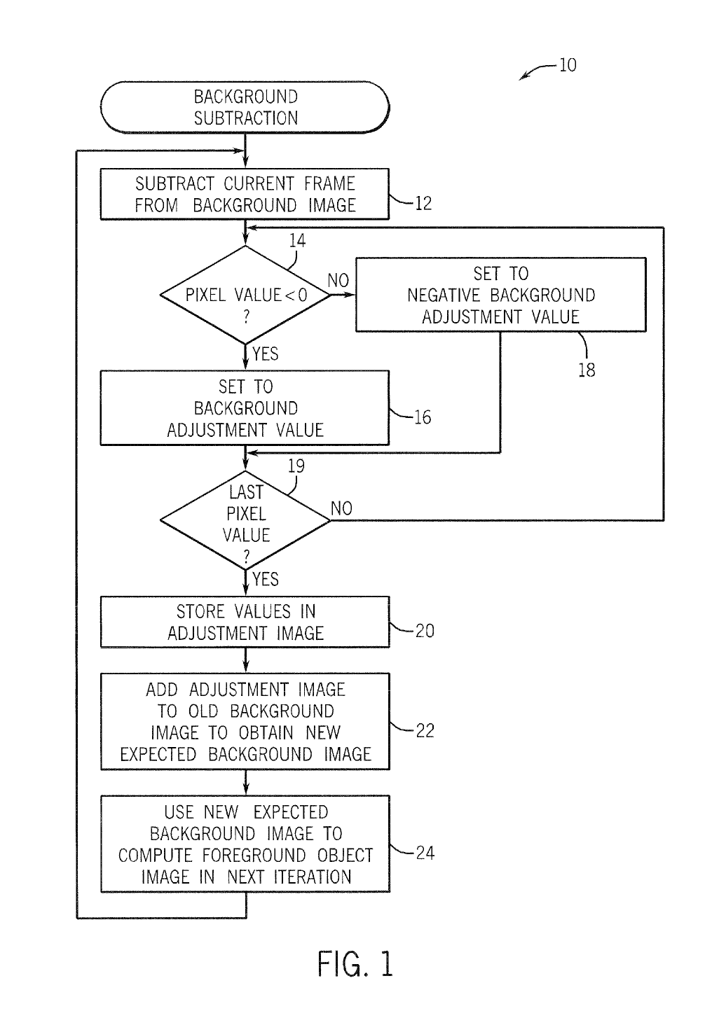

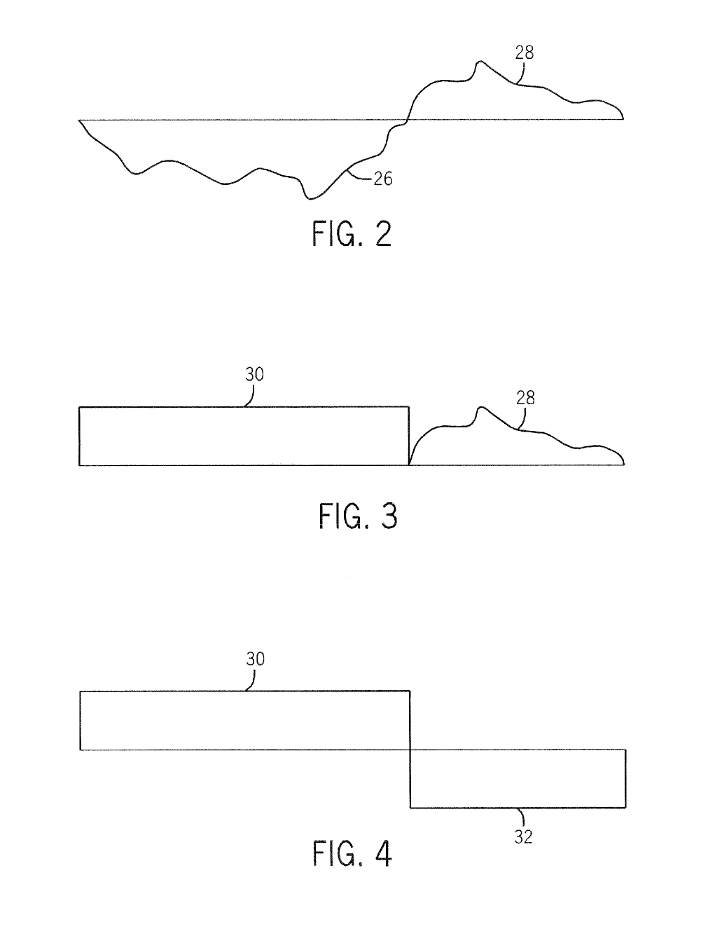

Thus, referring to FIG. 1, the new expected background image may be found by subtracting the current frame from the background image, as indicated in block 12. Subtraction is taking the difference in Y value across each pixel between the current frame and the background image. Y value here normally refers to the luminance value of a pixel. For frames using the RGB color space, Y may refer to each of the RGB values or a combination thereof, or a remapping of the R, G and B values to another representation of color or luminance. Then, a check at diamond 14 determines whether pixel values are less than zero. Pixel values of the resulting image that are less than zero are set to the background adjustment value, as indicated in block 16. The negative region 26, depicted in FIG. 2, is replaced by a constant background adjustment value 30 in FIG. 3, while the positive region 28 remains unaffected. The pixel values of the resulting image that are greater than zero are set to a negative background adjustment value, as indicated in block 18, as depicted in the example of FIG. 4. The positive values are indicated at 30 and the negative values are indicated at 32. But they are all set to one of the background adjustment value or the negative background adjustment value, which, in this example, are two constant values which happen to have the same magnitude. Of course, the background adjustment value could be negative, in which case the negative background adjustment value is positive. A check at diamond 19 determines whether the last pixel has been checked. If so, the flow continues on. Otherwise, the flow iterates through blocks 14, 16, and 18, pixel by pixel. Thus, the values are stored in the adjustment image, as indicated in block 20.

Next, the adjustment image is added to the old background image to obtain the new expected background image, as indicated in block 22. Then, the new expected background image is used to compute the foreground object image during the next iteration of the algorithm, as indicated in block 24.

Thus, in some embodiments, a new expected background image is iteratively computed from the old background image using each consecutive video frame. The new expected background image may be the result of adding a user defined value to the old background image such that the resulting new expected background image's pixel values are closer to the current video frame's pixel values. In some embodiments, the new expected background image of the current iteration may be used to compute the foreground image of the next video frame during the next iteration. Thus, in some embodiments, an intermediate matrix of background adjustment values may be computed to be added or subtracted from the old background image to form a new expected background image. Whether adding or subtracting is used depends on whether block 12 subtracts the old background image from the current image or vice versa, as well as on the polarity used for the background adjustment value. Then the background adjustment value may be set by the user to determine how fast the background of the image morphs to the current frame. A larger background adjustment value may cause the expected background image to morph to the current frame at a faster rate.

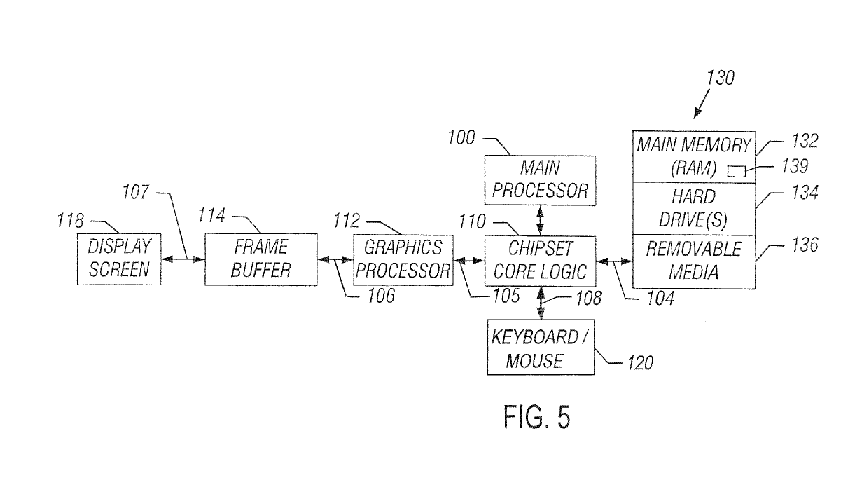

A computer system 130, shown in FIG. 5, may include a hard drive 134 and a removable medium 136, coupled by a bus 104 to a chipset core logic 110. A keyboard and mouse 120, or other conventional components, may be coupled to the chipset core logic via bus 108. The core logic may couple to the graphics processor 112, via a bus 105, and the central processor 100 in one embodiment. The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

In the case of a software implementation, the pertinent code may be stored in any suitable semiconductor, magnetic, or optical memory, including the main memory 132 (as indicated at 139) or any available memory within the graphics processor. Thus, in one embodiment, the code to perform the sequences of FIG. 1 may be stored in a non-transitory machine or computer readable medium, such as the memory 132, and/or the graphics processor 112, and/or the central processor 100 and may be executed by the processor 100 and/or the graphics processor 112 in one embodiment.

FIG. 1 is a flow chart. In some embodiments, the sequences depicted in this flow chart may be implemented in hardware, software, or firmware or a combination of hardware, software, or firmware. In a software embodiment, a non-transitory computer readable medium, such as a semiconductor memory, a magnetic memory, or an optical memory may be used to store instructions and may be executed by a processor to implement the sequences shown in FIG. 1.

The graphics processing techniques described herein may be implemented in various hardware architectures. For example, graphics functionality may be integrated within a processor or chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
iteratively computing a new expected background image from an old background image using a plurality of consecutive frames; and
adjusting pixel values of the old background image based on whether the pixel values are larger or smaller than the pixel values of each consecutive frame.

2. The method of claim 1 including computing the new expected background image to be closer to the current frame's pixel values.

3. The method of claim 1 including determining the new expected background image based on a user supplied value.

4. The method of claim 3 including adding said user supplied value to the old background image.

5. The method of claim 1 including using the new expected background image to compute the foreground image of the next video frame.

6. The method of claim 1 including enabling a user to define how fast the background image changes.

7. The method of claim 1 including subtracting a current frame from a background image, determining whether a pixel value is less than zero and, if so, setting the pixel value to a background adjustment value and, if not, setting the pixel value to a negative background adjustment value and storing the values in an adjustment image.

8. The method of claim 7 including adding or subtracting the adjustment image from the background image to produce an updated expected background image.

9. The method of claim 8 including iteratively using the updated expected background image to compute the next foreground image of the next video frame.

10. A non-transitory computer readable medium storing instructions to enable a processor to:
iteratively compute a new expected background image from an old background image using a plurality of consecutive frames; and
adjust pixel values of the old background image based on whether the pixel values are larger or smaller than the pixel values of each consecutive frame.

11. The medium of claim 10 further storing instructions to compute the new expected background image to be closer to the current frame's pixel values.

12. The medium of claim 10 further storing instructions to determine the new expected background image based on a user supplied value.

13. The medium of claim 12 further storing instructions to add said user supplied value to the old background image.

14. The medium of claim 10 further storing instructions to use the new expected background image to compute the foreground image of the next video frame.

15. The medium of claim 10 further storing instructions to enable a user to define how fast the background image changes.

16. An apparatus comprising:
a processor to iteratively compute a new expected background image from an old background image using a plurality of consecutive frames and to adjust pixel values of the old background image based on whether the pixel values are larger or smaller than the pixel values of each consecutive frame; and
a storage coupled to said processor.

17. The apparatus of claim 16, said processor to compute the new expected background image to be closer to the current frame's pixel values.

18. The apparatus of claim 16 including determining the new expected background image based on a user supplied value.

19. The apparatus of claim 18 including adding said user supplied value to the old background image.

20. The apparatus of claim 16 including using the new expected background image to compute the foreground image of the next video frame.
